(19) United States
(12) Patent Application Publication
(10) Pub. No.: US 2008/0016239 A1
(43) Pub. Date: Jan. 17, 2008

(54) Automatic method and system for securely transferring files

(75) Inventors: David Douglas Miller, Menlo Park, CA (US); Gary Raymond Clueit, Campbell, CA (US)

Correspondence Address: William L, Botjer, PO Box 478, Center Moriches, NY, 11934, US

(73) Assignee: Airzip Inc., Santa Clara, CA (US)

(21) Appl. No.: 11/879,815

(22) Filed: Jul. 19, 2007

Related U.S. Application Data
(63) Continuation of application No. PCT/US06/01824, filed on Jan. 19, 2006.
(60) Provisional application No. 60/645,504, filed on Jan. 20, 2005.

(51) Int. Cl. G06F 15/16

(52) U.S. Cl. 709/234

(57) ABSTRACT

A method, system, and computer program product for automatically securing and transferring a file from a sending user to one or more receiving users in a network. The file, which is in possession of the sending user, is submitted to a receiving location. Subsequently, the submitted file is secured. Thereafter, the secured file is sent to the receiving users through the network.

### RELATED APPLICATIONS

This application is a continuation of PCT Patent Application PCT/US2006/001824 which in turn claims priority of U.S. Provisional Patent Application Ser. No. 60/645504 entitled “Method and System for Securely Transferring Documents”, filed on Jan. 20, 2005.

### BACKGROUND OF THE INVENTION

The present invention generally relates to the field of networking. More particularly, the present invention relates to a method, a system, and a computer program product for automatically securing and transferring files, through a network.

A network includes data processing devices, for example, personal computers, laptops, scanners, mobile phones, and any other fixed or mobile devices. The network can be geographically constrained or global, wired or wireless, for example, a Local Area Network (LAN), a Metropolitan Area Network (MAN), or a Wide Area Network (WAN), such as the Internet. One of the primary functions of the network is that a user can access, via a data processing device, data or an application running on another data processing device. The network provides the mechanism for the transfer of files among the data processing devices.

Nowadays, there is a significant growth in the transfer of files among the data processing devices in the network. The files may be transferred by electronic mail, file transfer, web site downloads, or other similar methods. Many of these files contain information that is proprietary, confidential, or is required to be protected from unauthorized access by legal mandate. Therefore, along with this growth has come the increasing need to protect the confidentiality and security of these files, both whilst these files are in transit among the data processing devices, as well as when these files are stored on the data processing devices. These needs are driven by the insecure nature of, in particular, public networks and publicly accessible data processing devices.

Conventional methods for securing files include storage of files in secure repositories such as databases or file management systems, the use of Virtual Private Networks (VPNs) to protect files while in transit among the data processing units in the network, the use of firewalls to protect trusted internal networks from access by untrusted external users, and the use of encrypted file systems on data processing devices to protect the files whilst stored on the data processing devices, and enterprise or digital rights management systems.

The VPN extends a private communication network to allow remote data processing devices and users to communicate securely over a public network, for example, the Internet, using end-to-end encryption. Using a VPN, only authorized users are allowed to access the data transferred in the public network. This access can be provided on the basis of a user identification code and password. The VPN involves physical security and administrative security for protecting the data transfer. Further, the VPN involves securing the data while in transit between the public and the private communication network.

The firewall also referred to as a Border Protection Device (BPD) or packet filter, is a program or a hardware device that filters the data coming from the public network into the private communication network. In other words, the firewall builds a boundary around the data and prevents communication that is forbidden by the security policies. As a result, the VPN and the firewall build a boundary around the data but do not protect the data within the boundary. Consequently, the VPN and the firewall protect the data while the data is traversing the private communication network rather than the data itself. Once the data has reached its destination, the VPN and the firewall can no longer offer security or protection to the data.

This problem of securing the data while the data is outside of the VPN is carried out by various encryption techniques. In the case of encryption techniques, the data is encoded in such a way that only an authorized user can decode the encrypted data. These various encryption techniques make the data so obscure that it becomes inaccessible for unauthorized users. Therefore, the data is secured against any unauthorized use. However, encryption techniques are difficult to administer. This is because additional techniques are required to make the data secure, particularly to verify the integrity and the authenticity of the encoded data. Further, in the existing encryption techniques, a user needs to decide whether additional security features need to be incorporated with the data. Additionally, the user needs to decide whether the size of the data can be reduced through compression, if so, the user compresses the data before transmitting the data. Moreover, the user needs to decide one or more receiving users that can receive the data. Therefore, the encryption techniques require a lot of manual intervention for implementing the method. In addition to this, the encryption techniques do not secure the use of the data once an authentic user has accessed the data and do not prevent the authentic user from copying or re-distributing the data to unauthorized users. Further, in the case of encryption techniques, it is difficult to ensure that policies regarding the handling and distribution of the data are enforced, in most cases, this being left to manual compliance.

In light of the foregoing discussion, there exists a need for a method and a system that provides secure access to the data even after an authorized user has received the data. Further, there is a need for a method and a system that automates the process of securing and transferring the data. Still further, there is a need for a method and a system that does not require any human intervention for implementing the method. Still further, there is a need for a method and a system that allows the user to modify the access rights to the data even after the data has been transferred. Furthermore, there is a need for a method and system that tracks the use of the data whenever an authorized user accesses the data. Additionally, there is a need for a method and a system that is easy to administer.

### SUMMARY OF THE INVENTION

An object of the present invention is to provide a method, a system, and a computer program product for automatically securing and transferring a file from a sending user to one or more receiving users in a network.

Another object of the present invention is to provide a method, a system, and a computer program product for securing and transferring a file without any human intervention in the network.

Still another object of the present invention is to provide a method, a system, and a computer program product for tracking each access of the secured file in the network.

Yet another object of the present invention is to provide a method, a system, and a computer program product to allow the sending user to dynamically modify access rights of the receiving users for the secured file even after the secured file has been transferred to the receiving users.

Yet another object of the present invention is to provide a controlled transfer of the secured file in the network.

Various embodiments of the present invention relate to a method, a system and a computer program product for automatically securing and transferring a file from a sending user to one or more receiving users in the network.

The system includes a sending user, a system for submitting, a system for monitoring, a system for securing, a system for sending, a system for securing administration, a system for rights management, a system for viewing, and one or more receiving users. System for securing includes a system for compressing and a system for encrypting. System for rights management includes a system for authentication, a system for policy management, and a system for tracking and reporting.

The method involves transferring the file from the sending user to the receiving users in the network. Further, the method provides automatic submitting, compressing, encrypting, sending, and tracking of the file in the network. The receiving users and the access rights for the file can either be selected by the sending user or can be pre-defined by a system administrator.

Firstly, the system for submitting submits the file to a receiving location. The file may be submitted to this receiving location using standard system and network tools, or scanned to a file that is then placed in this receiving location. The file at the receiving location is monitored by the system for monitoring. The system for monitoring sends the file to the system for securing. The file is then optionally compressed by the system for compressing. The file is optionally compressed on the basis of the type of the file and the level of compression of the file. Subsequently, the compressed file is secured by using encryption techniques. The encryption techniques are applied by the system for encrypting. Further, the system for securing administration assigns access rights applicable to each the receiving users. The access rights persistently control access to the secured file by the receiving users. The secured file is then automatically sent by the system for sending to the receiving users. Further, system for authentication authenticates the receiving users. Each of the authenticated receiving users decrypts and de-compresses the secured file. The secured file is then viewed by the authenticated receiving users using the system for viewing. Further, the secured file is viewed by an authenticated receiving user on the basis of the access rights applicable to that authenticated receiving user for that secured file. Each access of the secured file by the receiving users is tracked by the system for tracking and reporting.

### BRIEF DESCRIPTION OF THE DRAWINGS

The preferred embodiments of the present invention will hereinafter be described in conjunction with the appended drawings provided to illustrate and not to limit the invention, wherein like designations denote like elements, and in which:

FIG. 1 is a block diagram of an exemplary network, wherein various embodiments of the present invention can be practiced;

FIG. 2 is a block diagram, illustrating a system for securely transferring a file from a sending user to one or more receiving users in a network, in accordance with an embodiment of the present invention;

FIG. 3 is a flowchart, illustrating the requisite steps for securely transferring a file from a sending user to one or more receiving users in a network, in accordance with an embodiment of the present invention;

FIG. 4 is a block diagram of a system for securely transferring a file from a sending user to one or more receiving users in a network, in accordance with another embodiment of the present invention;

FIGS. 5A and 5B comprise a flowchart, illustrating the detailed steps for securely transferring a file from a sending user to one or more receiving users in a network, in accordance with an embodiment of the present invention;

FIG. 6 is a flowchart, illustrating a system for monitoring the files that are submitted to the system, in accordance with an embodiment of the present invention;

FIG. 7 is a flowchart, illustrating a method for automatically modifying access rights of one or more receiving users, in accordance with an embodiment of the present invention;

FIG. 8 is a flowchart, illustrating a method for receiving a secured file in a network, in accordance with an embodiment of the present invention; and

FIG. 9 is a table, presenting an exemplary set of events related to configuration of the system and the access of a secured file, in accordance with an embodiment of the present invention.

### DESCRIPTION OF PREFERRED EMBODIMENTS

Various embodiments of the present invention relate to a method, system, and computer program product for automatically securing and transferring a file from a sending user to one or more receiving users in a network. This is achieved by submitting the file, which is in possession of the sending user to a receiving location. The submitted file is then secured. The submitted file is secured by encrypting the submitted file. The submitted file is encrypted on the basis of an encryption key. Thereafter, a policy is applied on the secured file. The policy may be a pre-defined policy or an overridden policy. The secured file is then sent to the receiving users. The method further involves tracking the access of the secured file, which is sent to the receiving users.

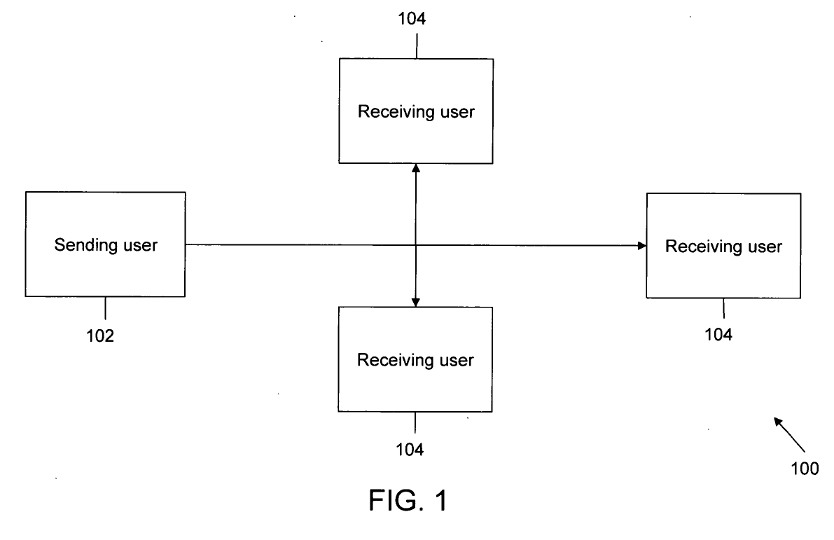

FIG. 1 is a block diagram of an exemplary network 100, wherein various embodiments of the present invention can be practiced. Network 100 includes a sending user 102 and one or more receiving users 104. In accordance with an embodiment of the present invention, sending user 102 and receiving users 104 are computer programs. Sending user 102 provides a file to receiving users 104. The file can be a document, an image, a text file, a computer program, a movie clip, or an audio clip. The file can be automatically transferred from sending user 102 to receiving users 104 through network 100.

Network 100 can be the Internet, intranet, extranet, wired or wireless, depending on the location of sending user 102 and receiving users 104. The method for automatically securing and transferring the file has been explained in detail in conjunction with the following figures.

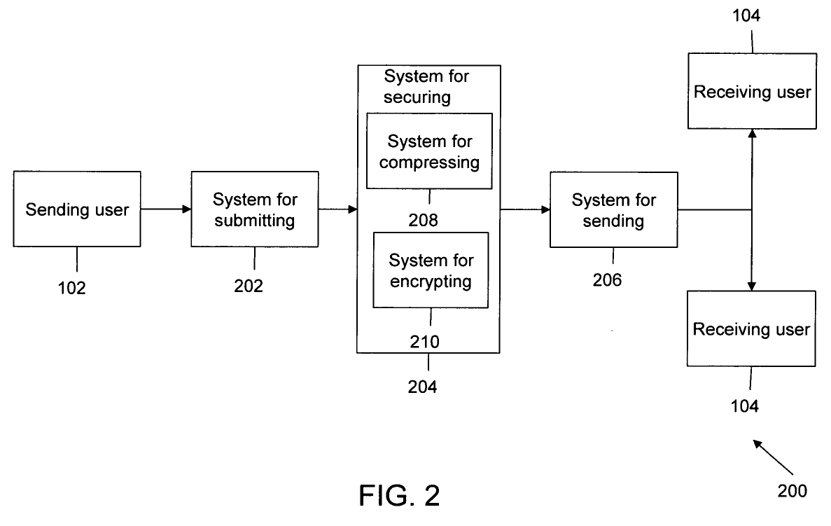

FIG. 2 is a block diagram, illustrating a system for securely transferring a file from sending user 102 to receiving users 104 in network 100, in accordance with an embodiment of the present invention. System 200 includes sending user 102, a system for submitting 202, a system for securing 204, a system for sending 206, and one or more receiving users 104. System for securing 204 includes a system for compressing 208 and a system for encrypting 210.

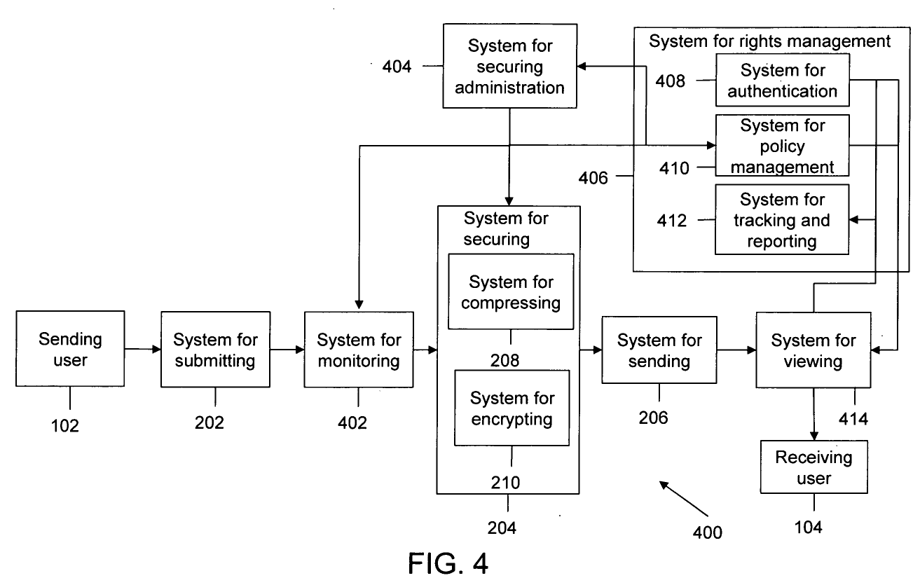

System for submitting 202 submits the file, which is in possession of sending user 102 to a receiving location. Subsequently, system for securing 204 secures the submitted file. The submitted file is secured by encrypting the submitted file. The submitted file is encrypted by system for encrypting 210. In accordance with an embodiment of the present invention, the submitted file can be compressed before encrypting the submitted file. The submitted file is compressed by system for compressing 208. After securing the file, system for sending 206 sends the secured file to receiving users 104. System 200 has been explained in detail in conjunction with FIG. 4.

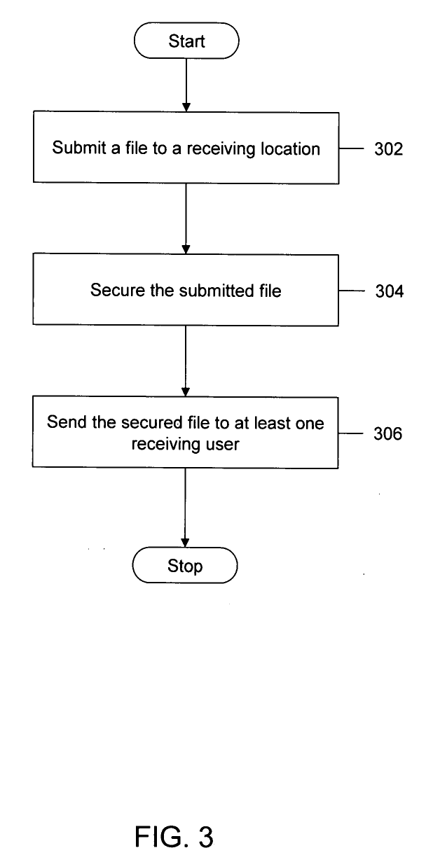

FIG. 3 is a flowchart, illustrating the requisite steps for securely transferring a file from sending user 102 to receiving users 104 in network 100, in accordance with an embodiment of the present invention. Sending user 102 provides a file to receiving users 104. At step 302, the file is submitted to a receiving location. In accordance with an embodiment of the present invention, the receiving location is a receiving folder. The receiving folder is an object that includes multiple files. The file is submitted by system for submitting 202. The file can be submitted through a scanner, file transfer, messaging, electronic mail (e-mail), Server Message Block (SMB), Network File System (NFS), Hyper Text Transport Protocol (HTTP), and copying. At step 304, the submitted file is secured. The submitted file is secured by system for securing 204. The submitted file is secured by encrypting the submitted file. The submitted file is encrypted on the basis of an encryption key. Subsequently, at step 306, the secured file is sent to receiving users 104. The secured file is sent to receiving users 104 by system for sending 206. The secured file can be sent to receiving users 104 through file transfer, messaging, e-mail, SMB, NFS, HTTP, copying, and physical media.

FIG. 4 is a block diagram of a system for securely transferring a file from sending user 102 to receiving users 104 in network 100, in accordance with another embodiment of the present invention. System 400 includes sending user 102, system for submitting 202, a system for monitoring 402, system for securing 204, system for sending 206, a system for securing administration 404, a system for rights management 406, a system for viewing 414, and receiving user 104.

System for securing 204 includes a system for compressing 208 and a system for encrypting 210. System for rights management 406 includes a system for authentication 408, a system for policy management 410, and a system for tracking and reporting 412.

Sending user 102 includes the file, which is to be sent to receiving users 104. Before securing and transferring the file, system 400 is set by an administrative function. The administrative function is present in system for monitoring 402. The administrative function defines one or more receiving locations. In accordance with an embodiment of the present invention, the receiving folders serve as the receiving locations. The administrative function retrieves a list of receiving users 104 and a list of access rights from system for policy management 410. The list of the access rights include the right to view the file, the right to modify the file, the right to print the file, the right to copy the file, and the right to forward the file. Further, the administrative function allocates receiving users 104 and a pre-defined policy to each of the one or more receiving locations.

Thereafter, system for submitting 202 submits the file to a receiving location. In accordance with an embodiment of the present invention, the receiving location is a pre-defined location. The file can be submitted through a scanner, file transfer, messaging, e-mail, SMB, NFS, HTTP, and copying. In accordance with an embodiment of the present invention, if the file is to be submitted through a scanner, then system for submitting 202 accesses the scanner before submitting the file. The scanner is accessed by system for submitting 202 to configure the receiving location. System for submitting 202 checks whether the scanner is capable of generating a metadata file that may contain policy overrides. If the scanner is capable of generating the metadata file then system for submitting 202 uploads the definitions required for generating the metadata file, to the scanner. Subsequently, system for submitting 202 accepts the file from sending user 102. The file submitted to the receiving location can be in an image format, an Adobe® Portable Document Format (PDF), or any other format.

In accordance with an embodiment of the present invention, the scanner includes flatbed scanners, double-sided scanners, Multi Function Peripherals (MFPs), handheld scanners, and computer programs capable of converting files to image format. The double-sided scanners can be used to scan loose sheets of paper. The flatbed scanners have a flat surface for placing the files to be scanned, and therefore, can also be used to scan bound files. The MFPs can perform several functions such as printing, scanning, faxing and photocopying. The file at the receiving location is monitored by system for monitoring 402.

Further, system for monitoring 402 invokes system for securing 204. In accordance with an embodiment of the present invention, system for securing 204 is invoked by submitting the file along with a pre-defined policy. The pre-defined policy for the receiving location of the file is defined by the administrative function. In accordance with an embodiment of the present invention, the pre-defined policy is overridden by sending user 102. The overridden policy is submitted to system for monitoring 402. The overridden policy is submitted as a metadata file. In accordance with an embodiment of the present invention, the metadata file is an Extensible Markup Language (XML) metadata file. The XML metadata file stores metadata of the file and includes instructions regarding the processing of the file. These instructions can include a list of receiving users 104 and a list of access rights associated for receiving users 104.

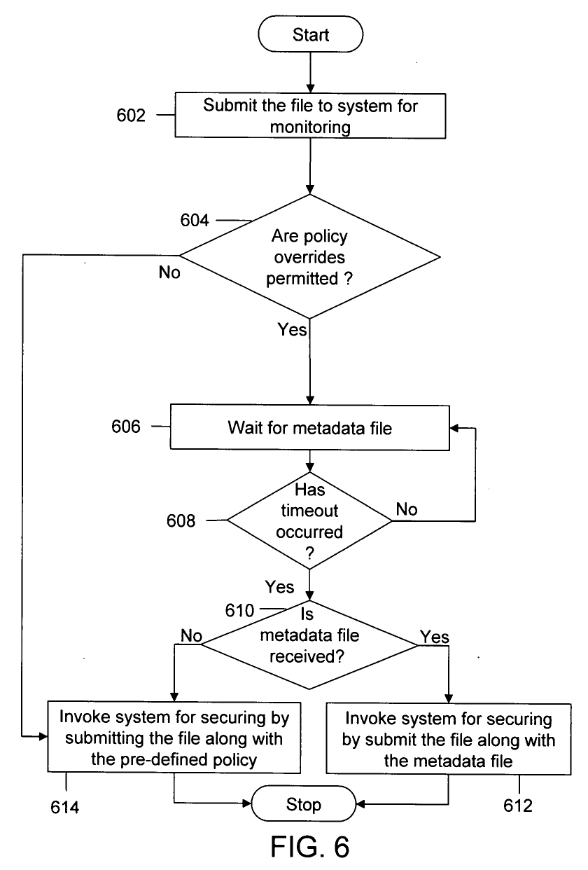

Further, system for monitoring 402 waits for the metadata file until a timeout occurs. The timeout is a pre-defined interval of time. If system for monitoring 402 receives the metadata file before the timeout, then system for monitoring 402 invokes system for securing 204 by submitting the file along with the metadata file. System for monitoring 402 has been explained in detail in conjunction with FIG. 6.

Thereafter, the invoked system for securing 204 secures the file received from system for monitoring 402. While securing the file, system for compressing 208 automatically determines the type of the file and the level of compression present in the file. Based on this information, system for compressing 208 compresses the file using various compression techniques. These compression techniques are based on a set of heuristics encoded in system for securing 204. The set of heuristics determine a suitable compression technique for each type of the file. In accordance with an embodiment of the present invention, if the file is a vector image in Graphic Interchange Format (GIF), Tagged Image File Format (TIFF), Portable Network Graphics (PNG) or other similar format, then system for compressing 208 may compress the file either by using the present assignee's patented AZV compression technique as shown in U.S. Pat. No. 6,748,116; which is incorporated by reference as if set forth herein in its entirety; or by any other suitable compression technique.

Further, system for securing 204 generates an encryption key for encrypting the file. In accordance with an embodiment of the present invention, the encryption key is Advanced Encryption Standard (AES) key with a size of 256 bits, also referred to as AES 256 key. AES is an encryption standard, which is symmetric, i.e., the same key is used for encryption and decryption. Key size refers to the number of bits with which the file can be encrypted at a time. The file is then encrypted by system for encrypting 210 on the basis of the encryption key. The file is encrypted by using various encryption techniques. For example, the encryption techniques include AES, Data Encryption Standard (DES), SSF08, SSF33, and many others.

After encrypting the file, system for securing administration 404 determines if the pre-defined policy is overridden by sending user 102. If the pre-defined policy is not overridden by sending user 102 then system for securing administration 404 applies the pre-defined policy to the encrypted file. However, if the pre-defined policy is overridden by sending user 102, then system for securing administration 404 applies the overridden policy on the encrypted file.

Once the policies are applied, system for securing 204 generates an identity for the encrypted file. The identity for the encrypted file is unique. Thereafter, the unique identity and the applied policy are stored in system for policy management 410. Also, the encryption key generated by system for securing 204 is registered in system for policy management 410.

Further, system for securing administration 404 determines a list of receiving users 104 and a method for sending the secured file to the list of receiving users 104. The method for sending the secured file can be file transfer, messaging, e-mail, SMB, NFS, HTTP, copying, and physical media. System for securing administration 404 determines the list of receiving users 104 and the method for sending the secured file to the list of receiving users 104, on the basis of the applied policy.

In the case where system for securing administration 404 determines that receiving user 104 present in the list of receiving users 104 is not registered with system for authentication 408 and an electronic address has been provided for this receiving user 104, then system for securing administration 404 registers this receiving user 104 in system for authentication 408. A user account for this receiving user 104 is automatically created in system for authentication 408. Further, system for securing administration 404 passes the information of this receiving user 104 to system for sending 206. Thereafter, system for authentication 408 notifies this receiving user 104 about the user account. Receiving user 104 is notified by system for authentication 408 using the electronic address of this receiving user 104.

Subsequently, system for securing 204 sends the secured file to system for sending 206. System for sending 206 sends the secured file to the list of receiving users 104. In accordance with an embodiment of the present invention, system for sending 206 sends the secured file using e-mail. In accordance with an embodiment of the present invention, system for sending 206 sends the secured file using a file transfer program. In accordance with an embodiment of the present invention, system for sending 206 sends the secured file to a web site via HTTP from where the secured file can be retrieved by receiving users 104. In accordance with an embodiment of the present invention, system for sending 206 sends the secured file using messaging middleware software that permits application components to create, send and receive and read messages, for example, Java Message Service (JMS), or IBM WebSphere® MQ. In accordance with an embodiment of the present invention, system for sending 206 sends the secured file to a recording device that stores the secured file on Write Once Read Many (WORM) or portable memory devices.

Receiving user 104 receives the secured file sent by system for sending 206. Thereafter, receiving user 104 invokes system for viewing 414 for accessing the secured file. Receiving users 104 may access the secured file through the file transfer program, from the web site or using the messaging middleware software, from a shared directory or from a physical media. System for viewing 414 authenticates the list of receiving users 104 against system for authentication 408. If receiving user 104 is an authenticated receiving user 104 then system for viewing 414 retrieves the encryption key and the applied policy from system for policy management 410. The encryption key and the applied policy are retrieved on the basis of the unique identity of the file. System for viewing 414 then decrypts the secured file on the basis of the encryption key. The decrypted file is then de-compressed. Further, the list of receiving users 104 views the file on the basis of the access rights of receiving users 104. The access rights of receiving users 104 are defined by the applied policy.

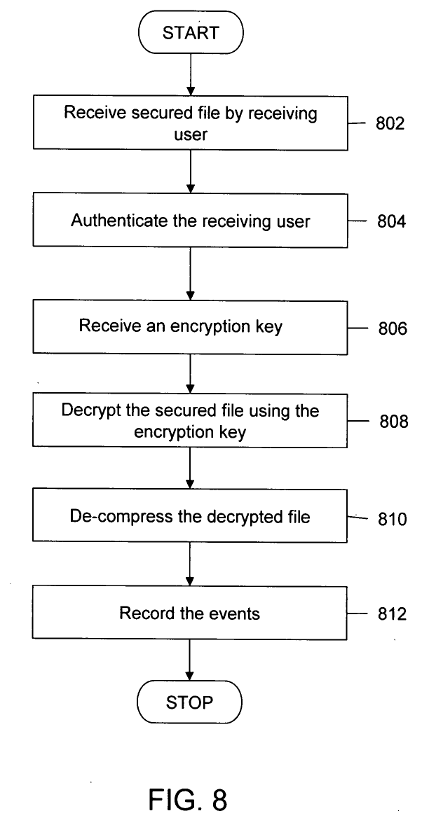

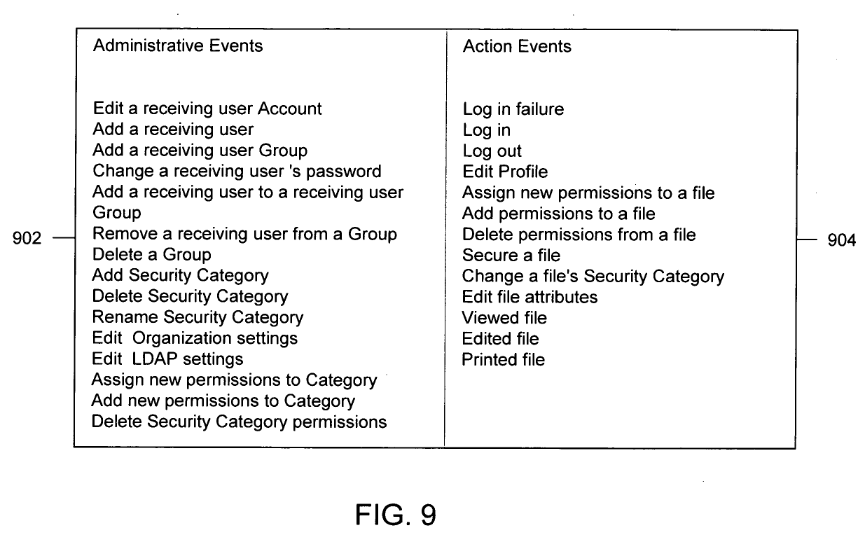

Further, system for tracking and reporting 412 tracks each access of the secured file by receiving users 104. System for tracking and reporting 412 also records events related to configuration of system 200 and the access of the secured file by receiving users 104. The events are recorded in a database. Further, system for tracking and reporting 412 uses certain procedures and techniques to identify and prevent tampering of the database. The events recorded by system for tracking and reporting 412 have been explained in detail in conjunction with FIG. 8 and FIG. 9.

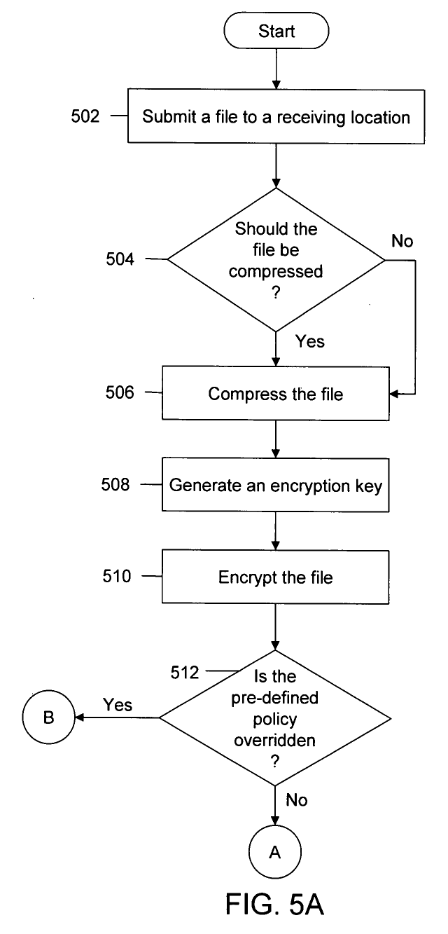

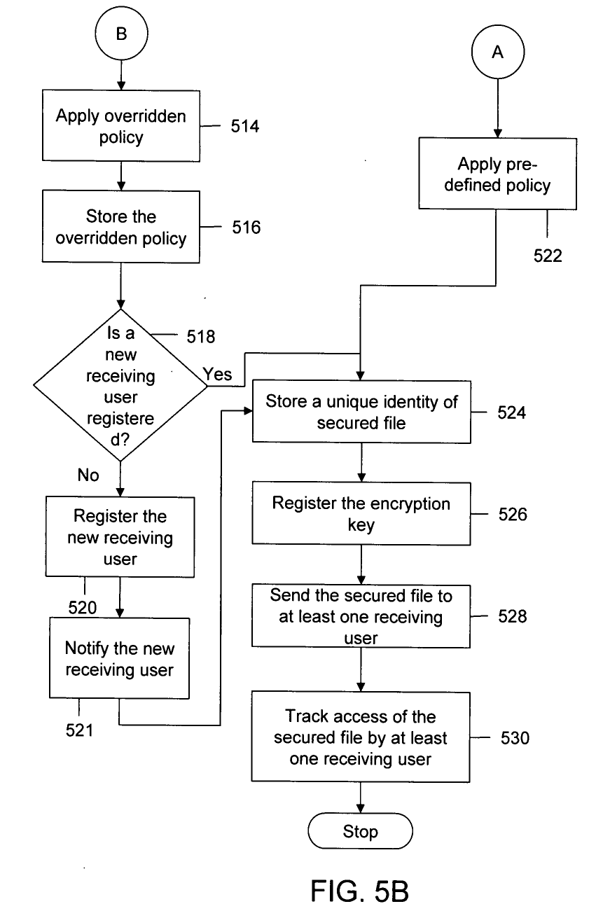

FIGS. 5A and 5B are a flowchart, illustrating the detailed steps for securely transferring a file from sending user 102 to receiving user 104 in network 100, in accordance with an embodiment of the present invention. At step 502, the file is submitted to a receiving location. The file is submitted by system for submitting 202. At step 504, system for compressing 208 checks whether the file should be compressed. If the file can be compressed then at step 506, the file is compressed. The file is compressed by system for compressing 208.

Then at step 508, an encryption key is generated. The encryption key is generated by system for securing 204. At step 510, the file is encrypted. The file is encrypted by system for encrypting 210. The file is encrypted on the basis of the encryption key generated by system for securing 204. At step 512, system for securing administration 404 checks whether the policy is overridden.

If the policy is overridden by sending user 102 then at step 514, the overridden policy is applied on the encrypted file. The overridden policy is applied by system for securing administration 404. At step 516, the overridden policy is stored. The overridden policy is stored in system for policy management 410. Thereafter, system for securing administration 404 determines a list of receiving users 104 on the basis of the overridden policy. At step 518, system for securing administration 404 checks if the list of receiving users 104 includes receiving user 104, which is not registered with system for authentication 408. If unregistered receiving user 104 exists then at step 520, receiving user 104 is registered. Receiving user 104 is registered with system for authentication 408. At step 521, receiving user 104 is notified. Receiving user 104 is notified by system for authentication 408.

However, if the policy is not overridden by sending user 102 at step 512, then the control proceeds to step 522. At step 522, the pre-defined policy is applied. The pre-defined policy is applied by system for securing administration 404.

At step 524, a unique identity associated with the secured file is stored. The unique identity of the secured file is stored in system for policy management 410. At step 526, the encryption key is registered. The encryption key is registered in system for policy management 410. At step 528, the secured file is sent to receiving users 104. The secured file is sent to receiving users 104 by system for sending 206. At step 530, access of the secured file by receiving users 104 is tracked. The access of the secured file by receiving users 104 is tracked by system for tracking and monitoring 412.

FIG. 6 is a flowchart, illustrating system for monitoring 402 for monitoring the files that are submitted to system for monitoring 402, in accordance with an embodiment of the present invention. At step 602, a file is submitted to system for monitoring 402. At step 604, system for monitoring 402 checks whether policy overrides are permitted on the file or not. If the policy overrides are permitted on the file, then at step 606, system for monitoring 402 waits for metadata file. The metadata file includes the overridden policy. At step 608, system for monitoring 402 checks whether timeout has occurred. If the timeout has not occurred then system for monitoring 402 waits for the metadata file at step 606. If the timeout has occurred then at step 610, system for monitoring 402 checks whether the metadata file has been received. If the metadata has been received, then at step 612, system for securing 204 is invoked by submitting the file along with the metadata file. If the metadata is not received then at step 614, system for securing 204 is invoked by submitting the file along with the pre-defined policy.

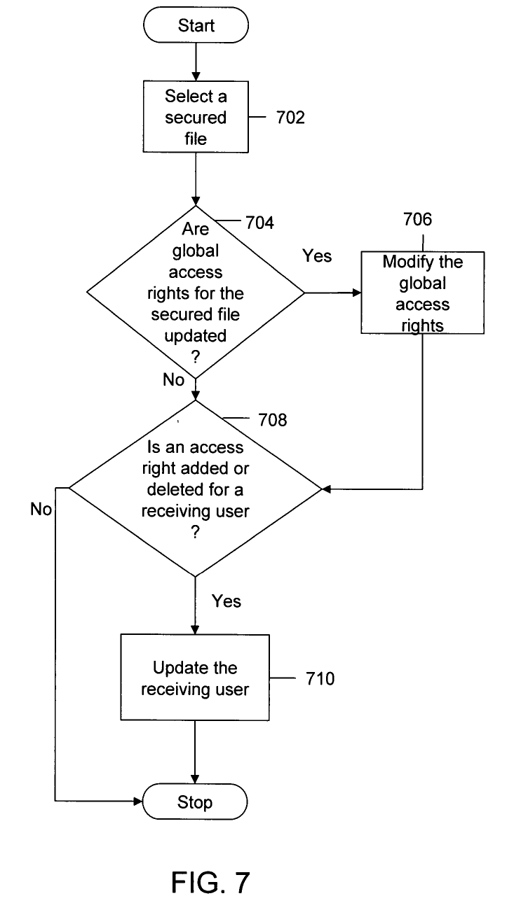

FIG. 7 is a flowchart, illustrating a method for automatically modifying access rights of receiving users 104 in accordance with an embodiment of the present invention. At step 702, a secured file is selected. The secured file is selected by sending user 102. At step 704, system for policy management 410 checks whether global access rights of the secured file are updated. The global access rights are the access rights that are applied to all receiving users 104. The global access rights for the secured file are updated by sending user 102. If the global access rights are updated then at step 706, the global access rights are modified. The global access rights are modified in a list of global access rights for the secured file. The list of global access rights is present in system for policy management 410. If the global access rights are not updated then at step 708, system for policy management 410 checks whether an access right is added or deleted for receiving user 104. If an access right is added or deleted for receiving user 104 then at step 710, corresponding receiving user 104 is updated. Receiving user 104 is updated by system for policy management 410. Subsequently, at step 712, system for policy management 410 is updated.

FIG. 8 is a flowchart, illustrating a method for receiving the secured file in network 100, in accordance with an embodiment of the present invention. At step 802, the secured file is received by receiving users 104. At step 804, system for authentication 408 authenticates receiving users 104. Subsequently, at step 806, each of receiving users 104 that are authenticated receives the encryption key. The encryption key is received from system for policy management 410. At step 808, the secured file is decrypted by using the encryption key. At step 810, the decrypted file is de-compressed. Once the decrypted file is de-compressed, it can be viewed by using system for viewing 414. At step 812, events are recorded. These events relate to the access of the secured file by receiving users 104. The events are recorded by system for tracking and reporting 412. Each recorded event contains an event identifier, an identifier for sending user 102, the secured file, address of network 100, and other information useful for analyzing and auditing the security of system 200. The various events have been explained in detail in conjunction with FIG. 9.

FIG. 9 is a table, presenting an exemplary set of events related to configuration of system 200 and the access of a secured file, in accordance with an embodiment of the present invention. These events include administrative events provided in a column 902 and action events provided in a column 904. Administrative events and action events are stored in a database for the purposes of auditing, forensics, and reporting. Administrative events include creation, deletion, and modification of receiving users 104, policies, configuration of system 200 and administrative tasks of system 200. Action events are concerned with access of the secured file by receiving users 104, policy enforcement, and policy changes on the secured file from the point at which the secured file is secured.

An exemplary administrative event provided in column 902 is the addition of receiving users 104 “add a receiving user”. Similarly, an exemplary action event provided in column 904 is the viewing of the image file “Viewed file”. In accordance with an embodiment of the present invention, sending user 102 can set an expiration date and time for the secured file, i.e., the secured file is available to receiving users 104 for only a limited time, based on the expiration date.

In accordance with another embodiment of the present invention, sending user 102 can set an available date or time for the secured file, i.e., the secured file is available to receiving users 104 at that particular date or time.

In accordance with an embodiment of the present invention, sending user 102 may set different expiration dates for different receiving users 104. In accordance with an embodiment of the present invention, receiving users 104 can temporarily store the encryption key and view the secured file.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. Computer comprises a microprocessor. Microprocessor is connected to a communication bus. Computer also includes a memory. Memory may include Random Access Memory (RAM) and Read Only Memory (ROM). Computer system further comprises storage device. It can be a hard disk drive or a removable storage device such as a floppy disk drive, optical disk drive and the like. Storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

System 200 and software for encryption and compression can be implemented on any platform by using standard operating system (OS) such as Microsoft Windows, Linux and UNIX variations, such as Sun Solaris and Apple Mac OS X. Also, the secured file can be viewed on any computer system by using any suitable application irrespective of the OS or platform. System 200 can use databases such as Apache Derby, IBM DB2, Microsoft SQL Server, Oracle, MySQL, Postgre, and other databases.

Various embodiments of the present invention relate to the automatically securing and transferring files from a sending user to one or more receiving users in a network. This is achieved by automatically submitting, monitoring, securing, and sending the files to the receiving users.

Various embodiments of the present invention facilitate a secure access of files in the network. The secure access of the files is achieved through a system for rights management. The system for rights management includes a system for authentication, a system for policy management, and a system for tracking and reporting. The system for authentication authenticates a receiving user. The system for policy management manages policies and access rights applied on the files. The access rights assigned to the receiving users can be updated at any time by the sending user or a system administrator. The receiving users also have the right to modify their own access rights.

Various embodiments of the present invention facilitate tracking of files, which are sent to the receiving users. This is achieved by a system for tracking and reporting that tracks each access of the files regardless of the location of the files in the network. The tracked events are provided in a report, which can be used as a proof of access.

Various embodiments of the present invention facilitate controlled access to sensitive information, which has already been sent to the receiving users. As a result, the files remain secure even after they have been received by an authentic receiving user.

Various embodiments of the present invention protect the receiving users against viruses. This is achieved by not running any executable code attached to the files while accessing the files by the receiving users. Moreover, the receiving users can instantly send the files to a new receiving user. Once the files are placed in a directory or a receiving folder within a system for monitoring, they are secured automatically.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. An automated method for securing and transferring a file from a sending user to at least one receiving user in a network, the method comprising the steps of:
a. submitting the file to a receiving location, the file being in possession of the sending user;
b. securing the file; and
c. sending the secured file to the at least one receiving user.

2. The method of claim 1, wherein the file is at least one of a document, an image, a text file, a computer program, a movie clip, and an audio clip.

3. The method of claim 1 further comprising the step of monitoring the submitted file.

4. The method of claim 1, wherein the step of securing the file comprises the step of compressing the file.

5. The method of claim 1, wherein the step of securing the file comprises the steps of:
a. encrypting the file; and
b. applying a policy on the encrypted file.

6. The method of claim 5, wherein the step of encrypting the file comprises the step of generating an encryption key, the encryption key being used for encrypting the file.

7. The method of claim 5, wherein the policy is a pre-defined policy.

8. The method of claim 7, wherein the pre-defined policy is overridden by the sending user.

9. The method of claim 8 further comprising the step of storing the overridden policy.

10. The method of claim 8 further comprising the step of registering a new receiving user to the at least one receiving user.

11. The method of claim 8 further comprising the step of submitting the overridden policy in the form of a metadata file.

12. The method of claim 1 1, wherein the metadata file is an Extensible Markup Language (XML) metadata file.

13. The method of claim 5, wherein the step of applying the policy comprises the step of assigning access rights to the at least one receiving user.

14. The method of claim 13, wherein the access rights are selected from a group consisting of the right to view the file, the right to modify the file, the right to print the file, the right to copy the file, and the right to forward the file.

15. The method of claim 13, wherein the access rights assigned to the at least one receiving user are updated by the sending user.

16. The method of claim 1 further comprising the step of tracking the access of the secured file, the secured file being accessed by the at least one receiving user.

17. The method of claim 1 further comprising the step of recording events, the events being related to the access of the secured file, the secured file being accessed by the at least one receiving user.

18. The method of claim 1 further comprising the steps of:
a. storing an identity of the file,.the identity being a unique identity of the file; and
b. registering an encryption key, the encryption key being used for encrypting the file.

19. The method of claim 1 further comprising the steps of:
a. receiving the file, the file being received by the at least one receiving user;
b. authenticating the at least one receiving user; and
c. viewing the file, the file being viewed by the authenticated receiving user based on access rights, the access rights being assigned to the authenticated receiving user.

20. The method of claim 1, wherein the step of submitting the file is performed through at least one of scanner, file transfer, messaging, e-mail, Server Message Block (SMB), Network File System (NFS), Hyper Text Transport Protocol (HTTP), and copying.

21. The method of claim 1, wherein the step of sending the file is performed through at least one of file transfer, messaging, e-mail, Server Message Block (SMB), Network File System (NFS), Hyper Text Transport Protocol (HTTP), copying, and physical media.

22. An automated system for securely transferring a file from a sending user to at least one receiving user in a network, the system comprising:
a. means for submitting the file to a receiving location, the file being in possession of the sending user;
b. means for securing the file; and
c. means for sending the secured file to the at least one receiving user.

23. The system of claim 22 further comprising means for monitoring the submitted file.

24. The system of claim 22, wherein the means for securing the file comprises means for compressing the file.

25. The system of claim 22 further comprising means for managing policies, the policies being applied to the file.

26. The system of claim 22, wherein the means for securing the file comprises:
a. means for encrypting the file; and
b. means for applying a policy on the encrypted file.

27. The system of claim 22 further comprising means for tracking and reporting events related to the access of the secured file, the secured file being accessed by the at least one receiving user.

28. The system of claim 22 further comprising means for authenticating the at least one receiving user.

29. The system of claim 22 further comprising means for viewing the file, the file being viewed by the at least one receiving user.

30. A computer program product for automatic secure transfer of a file from a sending user to at least one receiving user in a network, the computer program product comprising a computer readable medium comprising:
a. one or more instructions for submitting the file to a receiving location, the file being in possession of the sending user;
b. one or more instructions for compressing the file;
c. one or more instructions for storing an identity of the file, the identity being a unique identity of the file;
d. one or more instructions for generating an encryption key, the encryption key being used for encrypting the file;
e. one or more instructions for encrypting the file;
f. one or more instructions for registering the encryption key;
g. one or more instructions for applying a policy on the encrypted file;
h. one or more instructions for sending the secured file to the at least one receiving user;
d. one or more instructions for authenticating the at least one receiving user;
e. one or more instructions for viewing the secured file, the secured file being viewed by the authenticated receiving user based on access rights, the access rights being assigned to the authenticated receiving user; and
f. one or more instructions for tracking the access of the secured file, the secured file being accessed by the at least one receiving user.
g. one or more instructions for recording events, the events being related to the access of the secured file, the secured file being accessed by the at least one receiving user.
